(19) United States
(12) Patent Application Publication
(10) Pub. No.: US 2010/0225544 A1
(43) Pub. Date: Sep. 9, 2010

(54) SLOT ANTENNA AND PORTABLE WIRELESS TERMINAL

(76) Inventor: Toru Taura, Tokyo (JP)

Correspondence Address: Mr. Jackson Chen, 6535 N. STATE HWY 161, IRVING, TX, 75039, US

(21) Appl. No.: 12/600,214

(22) PCT Filed: May 15, 2008
(86) PCT No.: PCT/JP2008/058906

§ 371 Date: Nov. 13, 2009

(30) Foreign Application Priority Data
May 16, 2007 (JP) 2007-130848

(51) Int. Cl. H01Q 13/10; H01Q 1/24

(52) U.S. Cl. 343/702; 343/767

(57) ABSTRACT

To provide a portable wireless terminal having a reduced thickness and fine antenna performance. A slot antenna is provided with an antenna element having an aperture silt shaped slot; a reflection plate disposed by being opposed to the antenna element; and a power feeding device which is electrically and physically connected to the antenna element and the reflection plate. The slot antenna has a structure wherein an opening end of the slot and an end of the reflection plate are shifted from each other. Since only the antenna element and the reflection plate opposing to each other are disposed in the thickness direction (vertical direction) of the antenna, the size in the thickness direction of the antenna can be reduced. Further, through controlling the reactance component of the antenna, the characteristic of a transmitting/receiving antenna can be improved.

### TECHNICAL FIELD

The present invention relates to a slot antenna having a reflection plate. More specifically, the present invention relates to a thin-type slot antenna having a wideband characteristic and to a portable wireless terminal to which the slot antenna is loaded.

### BACKGROUND ART

Recently, portable wireless terminals have been required to be thin and to have a connecting function to various wireless networks. Accordingly, there has been an increasing demand for the antenna loaded on the portable wiring terminal to be thin because of limited mounting space and demand for widening the band required for being connected to various kinds of wireless services.

As the portable wireless terminals become thinner, the antennas loaded on the portable wireless terminals become susceptible to the external factors such as hands or human bodies because the distance between the antenna and the external factors becomes close when the portable wireless terminals are in use. This results in causing deterioration in the communication performance of the portable wireless terminals, particularly the deterioration of the antenna characteristic during communications, due to deterioration in the antenna characteristic.

As a structure for lightening the influence caused by the external factors, there is known a structure in which a metal plate (reflection plate) is interposed between the antenna and the external loss factor. In the antenna structure having the reflection plate, an operation band generally becomes narrower when the distance between the reflection plate and the antenna becomes closer. Thus, as a technique for widening the band of the antenna structure having the reflection plate, there is disclosed a structure in which a plurality of antenna elements are stacked (Patent Documents 1, 2, and 3).

As shown in FIG. 15A and FIG. 15B, the antenna structure disclosed in Patent Document 1 is achieved by loading a parasitic element 31 on an emission element 30 configured with a microstrip antenna, and power is fed from a coaxial cable 32 of the emission element 30 to implement a wideband by utilizing double resonance of the emission element 30 and the parasitic element 31. A reflector (reflection plate) 33 is attached by sloping towards both sides of the microstrip antenna.

As shown in FIG. 16, the band of the antenna structure disclosed in Patent Document 2 is widened by achieving a 2-frequency common characteristic through stacking two different microstrip antennas 40, 41 with different resonance frequencies vertically, and feeding power to each of the microstrip antennas 40, 41 from a coaxial cable 42, respectively.

As shown in FIG. 17, the antenna structure disclosed in Patent Document 3 enables operations in a plurality of frequency bands through disposing a load impedance switching circuit 52 between an antenna element 50 and a base plate 51, and controlling the resonance frequency of the antenna by connecting to a capacitive or inductive impedance element through switching the load impedance switching circuit 52. The load impedance switching circuit 52 is configured with a switching element, a capacitive impedance element, and an inductive impedance element.

### Patent Document 1: Japanese Unexamined Patent Publication 2001-326528

### Patent Document 2: Japanese Unexamined Patent Publication 2003-249818

### Patent Document 3: Japanese Unexamined Patent Publication H10-028013

### DISCLOSURE OF THE INVENTION

### Problems to be Solved by the Invention

However, the antenna structures disclosed in Patent Document 1 and Patent Document 2 are the structures in which the antenna elements are stacked vertically for achieving the double-resonance characteristic, so that the thickness of the antenna increases in the vertical direction.

The antenna structure disclosed in Patent Document 3 is capable of corresponding to a plurality of frequency bands by switching the resonance frequency. However, with the antenna structure of Patent Document 3, the band of the antenna itself remains as narrow, so that it is not possible to use a plurality of frequency bands simultaneously.

An object of the present invention is to provide a slot antenna which can be formed thin and can exhibit a fine antenna performance, and to provide a portable wireless terminal that uses the slot antenna.

### Means for Solving the Problem

In order to achieve the foregoing object, the slot antenna according to the present invention includes: an antenna element having an aperture silt shaped slot; a reflection plate disposed by being opposed to the antenna element; and a power feeding device which is electrically and physically connected to the antenna element and the reflection plate, wherein positions of an opening end of the slot and an end of the reflection plate are shifted from each other.

In the above explanation, the present invention is built as the slot antenna. However, the present invention is not limited only to such case. The present invention may also be built as a portable wireless terminal.

The portable wireless terminal according to the present invention has a slot antenna mounted into a casing of the portable wireless terminal, wherein the slot antenna includes: an antenna element having an aperture silt shaped slot; a reflection plate disposed by being opposed to the antenna element; and a power feeding device which is electrically and physically connected to the antenna element and the reflection plate, wherein positions of an opening end of the slot and an end of the reflection plate are shifted from each other.

### EFFECT OF THE INVENTION

With the present invention, it is possible to provide the slot antenna which can be formed in a thin type and can exhibit a fine antenna performance.

### BEST MODES FOR CARRYING OUT THE INVENTION

Hereinafter, an exemplary embodiment of the invention will be described by referring to the drawings.

As shown in FIG. 1-FIG. 9, a slot antenna according to the exemplary embodiment of the invention includes, as a basic structure: an antenna element 2 having an aperture silt shaped slot 1; a reflection plate 3 disposed by opposing to the antenna element 2; a power feeding device 4 which is electrically and physically connected to the antenna element 2 and the reflection plate 3; and an adjuster 5 which controls a reactance component of the antenna.

The slot antenna according to the exemplary embodiment of the invention reduces the reactance component of the antenna by adjusting the positional relation (adjuster 5) between an opening end of the slot 1 and the reflection plate. In a case of a transmitting antenna, the power feeding device 4 used for the slot antenna functions as a power feeding terminal which feeds power to the antenna element and the reflection plate for sending transmission signals. In a case of a receiving antenna, the power feeding device 4 functions as a power receiving terminal which takes in electric currents that are induced on the antenna by the incoming electromagnetic waves.

The antenna slot according to the exemplary embodiment of the invention can reduce the reactance component of the antenna by adjusting the layout state of the element antenna 2 and the reflection plate 3 functioning as the antenna, which are arranged to oppose to each other.

Therefore, only the antenna element 2 and the reflection plate 3 opposing to each other are disposed in the thickness direction (vertical direction) of the antenna, so that the size in the thickness direction of the antenna can be formed thin. Further, through controlling the reactance component of the antenna, the characteristic of the transmitting/receiving antenna can be improved. That is, in the case of the transmitting antenna, the transmission efficiency from the slot 1 can be improved. Furthermore, in the case of the receiving antenna, the reception efficiency of the slot 1 can be improved.

### Example 1

Next, the slot antenna according to EXAMPLE 1 of the present invention will be described based on FIG. 1A, FIG. 1B, and FIG. 1C.

In general, the slot antenna is formed by making a thin and long cut into a metal plate. In addition to the thin and long cut shape as the shapes of the slot, there is also a notch shape whose one end is an open end. EXAMPLE 1 is directed to the slot antenna having the latter shape, i.e., the notch shape.

As shown in FIG. 1A, FIG. 1B, and FIG. 1C, the slot antenna according to EXAMPLE 1 of the present invention has the antenna element 2, the reflection plate 3, the power feeding device 4, and the adjuster 5.

As shown in FIG. 1A and FIG. 18, the antenna element 2 is obtained by forming the slot 1 to a metal-made flat type emission plate 2a. The slot 1 is a hole-like shape having an electric length which corresponds to a quarter wavelength of the frequency to be used. An opening end 1a of the slot 1 is opened at an end 2b of the emission plate 2a, and a short-circuit end 1b of the slot 1 is disposed on the inner side than the end 2b of the emission plate 2. While the slot 1 of EXAMPLE 1 is formed in an L-letter shape, the present invention is not limited only to such case. That is, the slot 1 may be in any shapes as long as it is in the shape in which electric fields are concentrated at the opening end 1a of the slot 1.

As shown in FIG. 1A and FIG. 1B, the reflection plate 3 is disposed by being opposed to the antenna element 2. The external size of the reflection plate 3 is formed to be larger than the external size of the antenna element 2. The reflection plate 3 may be of a metal-made flat type or may be of a structure in which a reflection layer is formed on the surface of a resin plate, and the reflection plate 3 is disposed by opposing to the antenna element 2. The point is that the reflection structure may be of any types, as long as it is possible to reflect radio waves from the antenna element 2 towards the antenna element 2 efficiently.

As shown in FIG. 1C, the power feeding device 4 is connected to the antenna element 2 and the reflection plate 3 electrically and physically. As the power feeding device 4, it is possible to use a coaxial cable that is configured with a center conductor and an outer sheath conductor. The center conductor of the coaxial cable is connected to the antenna element 2 electrically and physically, and the outer sheath conductor of the coaxial cable is connected to the reflection plate 3 electrically and physically. To electrically and physically connect means that the power feeding device 4 is mechanically connected to the antenna element 2 and the reflection plate 3 and, while keeping that coupled state, the power feeding device 4 is electrically conductive to the antenna element 2 and the reflection plate 3.

In EXAMPLE 1, as shown in FIG. 1B and FIG. 1C, the power feeding device 4 is disposed on the short-circuit end 1b side of the slot 1, and the power feeding device 4 is electrically and physically connected to the antenna element 2 and the reflection plate 3. In a case where the coaxial cable is used as the power feeding device 4, the center conductor 4a and the outer sheath conductor 4b of the coaxial cable 4 are disposed on the short-circuit end side of the slot 1. Further, within an area A, the center conductor 4a of the coaxial cable 4 is electrically and physically connected to the antenna element 2, and the outer sheath conductor 4b is electrically and physically connected to the reflection plate 3.

Within the area A, when the power is fed from the power feeding device 4 to the slot 1 of the antenna element 2, an electric field and a magnetic field are generated in the slot 1. When the slot length becomes one fourth of the used frequency wavelength, there is generated the resonance with which the electric field becomes the maximum at the opening end 1a of the slot 1 and becomes the minimum at the short-circuit end 1b. This enables the slot antenna to function as the antenna.

The adjuster 5 is for controlling the reactance component of the antenna. Specifically, the adjuster 5 reduces the reactance component of the antenna by adjusting the position of the reflection plate with respect to the slot 1. The adjuster 5 of EXAMPLE 1 is formed in a structure in which the position of the opening end 1a of the slot 1 where the electric fields are concentrated and the position of the end 3a of the reflection plate 3 are shifted from each other. Specifically, the adjuster 5 of EXAMPLE 1 is in a structure in which the position of the opening end 1a of the slot 1 where the electric fields are concentrated is shifted by being projected with respect to the end 3a of the reflection plate 3.

In EXAMPLE 1, the adjuster 5 is in such a structure in which the position of the opening end 1a of the slot 1 where the electric fields are concentrated is shifted with respect to the end 3a H) of the reflection plate 3. Therefore, the reactance component can be decreased. In addition, the adjuster 5 of EXAMPLE 1 is in such a structure in which the position of the opening end 1a of the slot 1 where the electric fields are concentrated is shifted by being projected with respect to the end 3a of the reflection plate 3. Thus, the reflection plate 3 is not placed at the position opposing to the opening end 1a of the slot 1, so that it is possible to reduce the reactance component.

Next, described is a case where the slot antenna according to EXAMPLE 1 functions as a transmitting antenna.

When the power of the frequency having the electric length of the slot 1 as a quarter wavelength is fed to the antenna element 2 and the reflection plate 3 from the power feeding device 4, resonance is induced in the slot 1. Thereby, electromagnetic waves are emitted by the electric fields distributed on the slot 1 and the electric currents spread on the antenna element 2 and the reflection plate 3 from the slot 1. At this time, due to an effect of the reflection plate 3, the emission direction of the electromagnetic waves exhibits a directivity, and stronger emission is generated on the side where the slot 1 is disposed.

Next, described is a case where the slot antenna according to EXAMPLE 1 functions as a receiving antenna.

When the electromagnetic waves of the frequency having the electric length of the slot 1 as a quarter wavelength come in, electric currents are induced in the antenna element 2, and an electric field and a magnetic field are induced on the slot 1, respectively, which are received via the power feeding device 4. At this time, due to an effect of the reflection plate 3, the slot antenna exhibits a still higher sensitivity for the electromagnetic waves coming in from the side where the slot 1 is disposed.

In EXAMPLE 1, the opening end 1a of the slot 1 formed in the antenna element 2 is disposed by being shifted towards the outer side with respect to the end 3a of reflection plate 3. Therefore, the reactance component for the slot 1 can be decreased and the antenna band can be expanded. Particularly, the effects thereof become conspicuous by shifting the opening end 1a of the slot 1 where the strong electric field components are concentrated towards the outer side with respect to the end 3a of the reflection plate 3.

Further, through disposing the opening end 1a of the slot 1, it is possible to keep the end of the antenna element 2 away from the end 3a of the reflection plate 3. This makes it possible to avoid an increase in the thickness (vertical direction) of the antenna. Furthermore, induction of the induced electric currents which hinder emission and reception can be suppressed, so that it is possible to achieve an antenna which can be formed thin and can emit and receive electromagnetic waves efficiently.

The antenna element 2 and the reflection plate 3 can be shifted from each other in the left-and-right direction (in the lateral direction) of FIG. 1A. However, since the used frequency band is a high-frequency band such as 1.5 Ghz or 2.5 Ghz, the distance shifted in the lateral direction is extremely small (e.g., 2-3 mm). Thus, even when the antenna is mounted into a portable wireless terminal, for example, the antenna will not excessively occupy the space within the portable wireless terminal.

### Example 2

EXAMPLE 2 of the present invention is a modification of the adjuster 5 according to EXAMPLE 1 that is shown in FIG. 1. In EXAMPLE 1 shown in FIG. 1, the adjuster 5 is formed as a structure which controls the reactance component of the antenna by forming the opening end 1a of the slot 1 to project towards the outer side than the end 3a of the reflection plate 3. However, the structure of the adjuster 5 is not limited only to such case. It is possible to employ the adjuster 5 in a structure shown in EXAMPLE 2.

That is, as shown in FIG. 2A and FIG. 2B, the adjuster 5 shown in EXAMPLE 2 is formed in a structure in which the opening end 1a of the slot 1 where the electric fields are concentrated and the end 3a of the reflection plate 3 are shifted from each other. More specifically, the opening end 1a of the slot 1 where the electric fields are concentrated is disposed on the inner side with respect to the end 3a of the reflection plate 3, and a notch 3b opposing to the opening end 1a of the slot 1 is provided to the reflection plate 3. Structures other than that are the same as those of EXAMPLE 1 shown in FIG. 1.

In FIG. 2A and FIG. 2B, the notch 3b is formed in a recessed shape in which a part of the notch 3b opened to the outer side is formed at the end 3a of the reflection plate 3. However, the shape of the notch is not limited only to such case. The notch 3b is for reducing the reactance component of the antenna. Thus, instead of the structure in which a part of the notch is opened to the outer side, the notch may be formed in a closed hole structure that has a sufficient opening area for reducing the reactance component.

In the case of EXAMPLE 2, the notch 3b is provided to the reflection plate 3 at a place opposing to the slot 1 that is disposed on the inner side with respect to the end 3a of the reflection plate 3. Thus, the reactance component for the slot 1 can be reduced by the notch 3b, so that the antenna band can be expanded. Particularly, the effects thereof become conspicuous through providing the notch 3b at a position of the reflection plate 3, which faces up against the opening end 1a of the slot 1 where the electric fields are concentrated.

In FIG. 2, the position of the antenna element is set to a center area of the reflection plate 3. However, it is not limited only to that area. It is also possible to dispose the antenna element 2 and the reflection plate 3 at positions opposing to each other by having the end 2a of the antenna element 2 on the side where the opening end 1a of the slot 1 is provided aligned with the end 3a of the reflection plate 3, as long as the antenna element 2 and the reflection plate 3 are disposed at positions opposing to each other.

### Example 3

EXAMPLE 3 of the present invention is a modification of the adjuster 5 according to EXAMPLE 1 that is shown in FIG. 1. In EXAMPLE 1 shown in FIG. 1, the adjuster 5 is formed as a structure which controls the reactance component for the slot 1 by forming the opening end 1a of the slot 1 to project towards the outer side than the end 3a of the reflection plate 3. However, the structure of the adjuster 5 is not limited only to such case. It is also possible to employ the adjuster 5 in a structure shown in EXAMPLE 3.

The adjuster 5 of EXAMPLE 3 is formed in a structure in which a notch 3c opposing to the opening end 1a of the slot 1 where the electric fields are concentrated is formed at the end 3a of the reflection plate 3.

That is, as shown in FIG. 3A and FIG. 3B, the notch 3c is provided at the end 3a of the reflection plate 3 opposing to the opening end 1a of the slot 1 to reduce the reactance component of the antenna by the notch 3c. Further, in the end of the antenna element 2, the notch 3c is formed towards the length direction along the end 2a of the antenna element 2 where the electric currents as the emission source are distributed.

In this case, the end 2a of the antenna element 2 and the end 3a of the reflection plate 3 may be aligned with each other as shown in the drawing or may be shifted from each other in the lateral direction.

The adjuster 5 of EXAMPLE 3 is formed in the structure in which the notch 3c opposing to the opening end 1a of the slot 1 where the electric fields are concentrated is formed at the end 3a of the reflection plate 3. Thus, the reactance component for the slot 1 can be reduced by the notch 3c, so that the antenna band can be expanded. Particularly, the effects thereof become conspicuous through forming the notch 3c towards the length direction along the opening end 1a of the slot 1 where the electric field components are concentrated and the end 2a of the antenna element 2 where the electric currents as the emission source are distributed.

### Example 4

EXAMPLE 4 is a modification of the adjusters 5 of EXAMPLE 2 and EXAMPLE 3, in which the position of the short-circuit end 1b of the slot 1 is taken into consideration.

As shown in FIG. 4A and FIG. 4B, in EXAMPLE 4, the short-circuit end 1b of the slot 1 is disposed at the position opposing to the reflection plate 3. That is, while the notch 3d (3b, 3c) is provided to the reflection plate 3 in EXAMPLE 2 and EXAMPLE 3, the notch 3d (3b, 3c) is provided by being opposed to the short-circuit end 1b of the slot 1 in EXAMPLE 4, which affects the antenna characteristic.

In EXAMPLE 4, the size of the notch 3d (3b, 3c) provided to the reflection plate 3 or the shift amount of the antenna element 2 with respect to the reflection plate 3 is defined to arrange the short-circuit end 1b of the slot 1 at the position opposing to the reflection plate 3.

That is, the cutout amount for the notches 3b and 3c of EXAMPLE 2 and EXAMPLE 3, i.e., the distance from the end 3a of the reflection plate 3 to the bottom of the notch 3d (3b, 3c) is defined as d. Further, in EXAMPLE 2 and EXAMPLE 3, the distance between the opening end 1a of the slot 1 shifted with respect to the end 3a of the reflection plate 3 is defined as d. Furthermore, the distance from the end 2a of the antenna element 2 where the opening end 1a of the slot 1 is opened to the short-circuit end 1b of the slot 1 bent in an L-letter shape is defined as dmax.

Under the condition described above, the distance d is set to be within a range of zero, inclusive, to dmax, exclusive, to dispose the short-circuit end 1b of the slot 1 to the position opposing to the reflection plate 3. However, in a case where the power feeding device 4 is disposed within that range, the reflection plate 3 needs to be in that range. Thus, the above does not apply in that case. Other than those are the same as the case of EXAMPLE 1.

In EXAMPLE 4, the size of the notch 3d (3b, 3c) provided to the reflection plate 3 or the shift amount of the antenna element 2 with respect to the reflection plate 3 is defined to arrange the short-circuit end 1b of the slot 1 at the position opposing to the reflection plate 3. Thus, through expanding the notch opposing to the opening end 1a of the slot 1 as wide as possible, the reactance component for the slot can be reduced, thereby making it possible to expand the antenna band.

The notch 3d (3b, 3c) provided to the end 3a of the reflection plate 3 can extend the length thereof in the length direction of the end 3a of the reflection plate 3. Thus, regarding the emitting direction of the electromagnetic waves, the extent of the emission is gradually increased towards the back-face side (on the side where the reflection plate 3 is disposed) of the antenna in accordance with the extent of the expansion in the length of the notch 3d (3b, 3c). Therefore, the emission directivity can be controlled by defining the length of the notch 3d (3b, 3c).

Particularly, the area in the vicinity of the short-circuit end 1b of the slot 1 is where the antenna electric currents are concentrated. Thus, through having the short-circuit end 1b of the slot 1 opposed to the reflection plate 3, i.e., through having the short-circuit end 1b of the slot 1 opposed to the reflection plate 3 by avoiding the notches 3b, 3c, the emission amount of the electromagnetic waves towards the reflection plate 3 side can be controlled.

FIG. 5A shows the antenna impedance characteristic of the slot antenna according to EXAMPLE 1. FIG. 5B shows the antenna impedance characteristic of the slot antenna according to EXAMPLE 2. FIG. 5C shows the antenna impedance characteristic of a slot antenna according to a related technique. In FIG. 5, the longitudinal axis is a return loss (dB), and the horizontal axis is the frequency (Hz).

As can be seen by comparing FIG. 5A, FIG. 5B, and FIG. 5C, through employing the structures of the adjuster 5 according to EXAMPLE 1 and EXAMPLE 2, the band of the antenna can be widened compared to the case of the related technique shown in FIG. 5C.

### Example 5

EXAMPLE 5 is a modification of EXAMPLE 1 that is shown in FIG. 1. In EXAMPLE 1, the slot 1 provided to the antenna element 2 is a single-resonance type slot, i.e., a structure in which a single slot 1 is provided to the antenna element 2. However, the slot is not limited only to such type. As in EXAMPLE 5, the slot may be a double-resonance type slot.

That is, as shown in FIG. 6A, FIG. 6B, and FIG. 6C, double-resonance type slots 1, 1′ are provided to the antenna element 2 in EXAMPLE 5. In that case, the slot 1, 1′ configuring the double-resonance type slot are provided to the antenna element 2 in different length from each other. Structures other than that are the same as those of EXAMPLE 1 shown in FIG. 1.

In EXAMPLE 5, the double-resonance type slot is provided to the antenna element 2, i.e., the two slots 1 and 1′ in different lengths are provided to the antenna element 2. Thereby, it is possible to have resonance at frequencies that depend on each of the slot lengths, so that the antenna of the wider band than that of EXAMPLE 1 can be achieved.

### Example 6

EXAMPLE 6 shown in FIG. 7 is a modification of EXAMPLE 5 shown in FIG. 6. In EXAMPLE 5, the double-resonance type slots 1 and 1′ are provided at a same side of the antenna element 2. However, the way of providing the slots is not limited only to that case.

As shown in FIG. 7A, FIG. 7B, and FIG. 7C, the double-resonance type slots 1 and 1′ are separately provided at two opposing sides of the antenna element 2 in EXAMPLE 6. Specifically, the width of the antenna element 2 is widened than the width of the reflection plate 3. Further, the slot 1 is provided at one of opposing ends of the antenna element 2 while the slot 1′ is provided at the other end, and the opening ends 1a and 1a′ of the slots 1 and 1′ are projected towards the outer side than the end 3a of the reflection plate 3. The slots 1 and 1′ are formed in different lengths from each other. Other structures are the same as those of EXAMPLE 1.

In EXAMPLE 6, the double-resonance type slots 1 and l′ in different lengths are provided to the opposing ends of the antenna element 2. Thereby, it is possible to have resonance at frequencies that depend on each of the slot lengths, so that the antenna of the wider band than that of EXAMPLE 1 can be achieved.

EXAMPLE 7 shown in FIG. 8 is a modification of EXAMPLE 2 shown in FIG. 2.

EXAMPLE 8 shown in FIG. 9 is a modification of EXAMPLE 3 shown in FIG. 3.

EXAMPLE 9 shown in FIG. 10 is a modification of EXAMPLE 4 shown in FIG. 4.

### Example 7

In EXAMPLE 7 shown in FIG. 8A and FIG. 8B, the double-resonance type slots 1 and 1′ are provided at a same side of the antenna element 2 instead of the single-resonance type slot 1 of EXAMPLE 2 shown in FIG. 2. In this case, notches 3b and 3b′ opposing to the double-resonance type slots 1 and 1′ are formed at the same end 3a of the reflection plate 3. Other structures including the opening ends 1a, 1a′ and the short-circuit ends 1b, 1b′ of the slots 1, 1′ are the same as those shown in FIG. 2.

### Example 8

In EXAMPLE 8 shown in FIG. 9A and FIG. 9B, the double-resonance type slots 1 and 1′ are provided at a same side of the antenna element 2 instead of the single-resonance type slot 1 of EXAMPLE 3 shown in FIG. 3. In this case, notches 3c opposing to the double-resonance type slots 1 and 1′ commonly oppose to the opening ends 1a, 1a′ of the double-resonance type slots 1, 1′ to reduce the reactance component for the slots 1, 1′. Other structures including the opening ends 1a, 1a′ and the short-circuit ends 1b, 1b′ of the slots 1, 1′ are the same as those shown in FIG. 3.

### Example 9

In EXAMPLE 9 shown in FIG. 10A and FIG. 10B, the double-resonance type slots 1 and 1′ are provided at a same side of the antenna element 2 instead of the single-resonance type slot 1 of EXAMPLE 4 shown in FIG. 4. In this case, notches 3d opposing to the double-resonance type slots' 1 and 1′ commonly oppose to the opening ends 1a, 1a′ of the double-resonance type slots 1, 1′ to reduce the reactance component for the slots 1, 1′. Other structures including the opening ends 1a, 1a′ and the short-circuit ends 1b, 1b′ of the slots 1, 1′ are the same as those shown in FIG. 4.

In EXAMPLE 7 shown in FIG. 8, EXAMPLE 8 shown in FIG. 9, and EXAMPLE 9 shown in FIG. 10, the double-resonance type slots 1 and 1′ are formed in different lengths.

In EXAMPLE 7 shown in FIG. 8A and FIG. 8B, EXAMPLE 8 shown in FIG. 9A and FIG. 9B, and EXAMPLE 9 shown in FIG. 10A and FIG. 10B, the double-resonance type slots 1 and 1′ of different lengths are provided to the antenna element 2. Thereby, it is possible to have resonance at frequencies that depend on each of the slot lengths, so that the antenna of the wider band than the cases of EXAMPLES 2, 3, and 4 can be achieved.

FIG. 11A shows the impedance characteristic of the antenna having the double-resonance type slots according to EXAMPLE 5. FIG. 11B shows the impedance characteristic of the antenna having the double-resonance type slots according to EXAMPLE 6. FIG. 11C shows the impedance characteristic of the antenna having the double-resonance type slots according to a related technique. In FIG. 11, the longitudinal axis is a return loss (dB), and the horizontal axis is the frequency (Hz).

As can be seen by comparing FIG. 11A, FIG. 11B, and FIG. 11C, through employing the double-resonance type slots 1 and 1′ of EXAMPLE 5 and EXAMPLE 6, it is possible to expand the band of the antenna compared to the case of the related technique shown in FIG. 11C.

In the explanations above, the shape of the slot 1 provided on the antenna element 2 is described as an L-letter shape. However, the shape is not limited only to that shape. For example, through selecting the shape of the slot 1 appropriately from shapes such as a straight type, a meander type, a U-letter shape, and a Bow-Tie type, it is possible to have resonance, antenna actions, and sensitivities for polarized waves in the horizontal or vertical direction at low frequencies while reducing the area occupied by the slot. Further, while the number of slots 1 has been described as one or two by referring to the case of EXAMPLE 1 where there is one slot and the case of EXAMPLE 5 where there are two slots, it is possible to employ a structure having a multiple resonance characteristic by providing two or more slots. Furthermore, there has been described above assuming that there is one power feeding device 4. However, two or more power feeding devices 4 may be loaded as well. Moreover, when there are two or more slots 1 disposed on the antenna element 2, the power feeding device 4 may be provided to each of the slots 1.

The slot antenna described by referring to EXAMPLES above may be mounted to a portable terminal such as a portable telephone, for example.

### Example 10

As shown in FIG. 12A and FIG. 12B, a portable wireless terminal according to EXAMPLE 10 is formed in a structure in which: two casings 10a and 10b are connected in a foldable manner via a hinge 11; a display unit 12 of liquid crystal is loaded on the inner face of one casing 10a; a plurality of operation buttons 13 are mounted into the inner face of the other casing 10b; and a circuit element (not shown) for executing functions necessary for the portable wireless terminal is mounted inside the two casings 10a and 10b. The display unit 12, the operation buttons 13, and the circuit element (not shown) are of widely-used types, and are not the feature elements of the present invention. Therefore, detailed explanations thereof are omitted. FIG. 12B shows a state where a back lid of the casing 10b is removed.

As shown in FIG. 12B, the portable wireless terminal according to EXAMPLE 10 has the slot antenna of EXAMPLE 1 shown in FIG. 1 mounted within the casing 10a by utilizing a vacant space on the back side of the display unit 12.

### Example 11

As shown in FIG. 13A and FIG. 13B, a portable wireless terminal according to EXAMPLE 11 is formed in a structure in which: a casing 10 is formed in a straight type, i.e., in a unfoldable type; a display unit 12 and operation buttons 13 are mounted into the front face of the casing 10; and a circuit element (not shown) for executing functions necessary for the portable wireless terminal is mounted inside the casing 10. The display unit 12, the operation buttons 13, and the circuit element (not shown) are of widely-used types, and are not the feature elements of the present invention. Therefore, detailed explanations thereof are omitted. FIG. 13B shows a state where a back lid of the casing 10 is removed.

As shown in FIG. 13B, the portable wireless terminal according to EXAMPLE 11 has the slot antenna of EXAMPLE 1 shown in FIG. 1 mounted within the casing 10 by utilizing a vacant space on the back side of the display unit 12.

Note that the slot antenna mounted to the portable wireless terminal according to EXAMPLE 10 and EXAMPLE 11 is not limited to the antenna of EXAMPLE 1. It is also possible to mount the slot antennas according to EXAMPLES 2-8 to the portable wireless terminal, instead of the slot antenna of EXAMPLE 1.

In the portable wireless terminal according to EXAMPLE 10 and EXAMPLE 11, the reflection plate 3 disposed at the position opposing to the antenna element 2 of the slot antenna is arranged to be at a position capable of reducing the influence to the antenna characteristic caused due to the external factors, i.e., the reflection plate 3 is placed at a position on the user's body side during communications.

Note here that while the antenna element 2 and the reflection plate 3 as the structural elements of the slot antenna may be mounted, respectively, within the casing 10, the casing 10a, and the casing 10b as the members used exclusively, the antenna element 2 and the reflection plate 3 may be formed as structures that are used in common also for other members configuring the casings. For example, a solid ground pattern of a built-in printed circuit board or a metal plate for holding an LCD or the like may be used also as the reflection plate 3. When the casing itself is made of a metal, the slot 1 may be provided to the casing, and the opening part of the slot 1 may be sealed by a resin or the like to use the casing also as the antenna element 2. Further, when the casing is made of a resin, a pattern of the slot 1 may be formed on the surface of the casing by metal plating, vapor deposition, or the like. Other than those, it is also possible to employ a structure in which the casing and the antenna element are integrated through integrally molding the metal-plate antenna element 2 together with the resin casing.

### Example 12

A portable wireless terminal according to EXAMPLE 12 is an improved terminal of the portable wireless terminal according to EXAMPLE 10. With the portable wireless terminal according to EXAMPLE 10, there are cases where the metal plate 14 mounted into the casing 10b may cover the opening end 1a of the slot 1 of the slot antenna when the two casings 10a and 10b are being folded.

As shown in FIG. 14A, FIG. 14B, and FIG. 14C, in the portable wireless terminal according to EXAMPLE 12, the size of the metal plate 14 mounted into the casing 10b is aligned with the size of the reflection plate 3, and the metal plate 14 is disposed at a position that is symmetrical with the position of the reflection plate 3 with respect to the hinge 11. FIG. 14B and FIG. 14C show the state where the back lid of the casing is removed.

Therefore, the metal plate 14 comes at the same position as that of the reflection plate 3 in the state where the casings 10a and 10b are being folded, so that it does not interfere with the opening end 1a of the slot 1. Thus, it is possible to keep the reduction of the reactance component of the antenna by the adjuster 5. Therefore, deterioration in the antenna characteristic can be avoided even when the casings are being folded.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2007-130848 filed on May 16, 2007, and the disclosure thereof is hereby incorporated by reference in its entirety.

### INDUSTRIAL APPLICABILITY

As described above, the present invention is capable of reducing the reactance component of the antenna, so that the band of the antenna can be widened. Further, induction of the induced electric current which hinders emission of electromagnetic waves can be suppressed without increasing the thickness of the antenna, thereby making it possible to achieve a thin-type antenna with a fine emission efficiency.

The structure for reducing the reactance component does not need to increase the number of structural elements of the antenna. Therefore, there is no factor for increasing the cost, so that the antenna in such structure can be achieved at a low cost.

Further, through adjusting the proportion regarding reduction of the reactance component appropriately, the emission power amount towards the back face side of the antenna can be controlled. Thus, even when the antenna is loaded on the portable wireless terminal, influences caused due to the user's body or the like are small. As a result, it is possible to achieve a thin-type portable wireless terminal that exhibits a fine characteristic during communications.

### BRIEF DESCRIPTION OF THE DRAWINGS

FIG. 1A is a perspective view showing a slot antenna according to EXAMPLE 1 of the present invention, FIG. 1B is a plan view showing the slot antenna according to EXAMPLE 1 of the present invention, and FIG. 1C is a sectional view showing the slot antenna according to EXAMPLE 1 of the present invention;

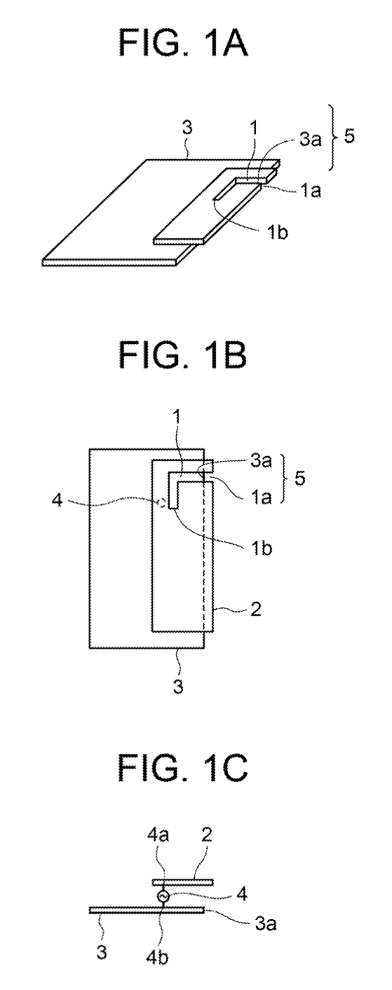

FIG. 2A is a perspective view showing a slot antenna according to EXAMPLE 2 of the present invention, and FIG. 2B is a plan view showing the slot antenna according to EXAMPLE 2 of the present invention;

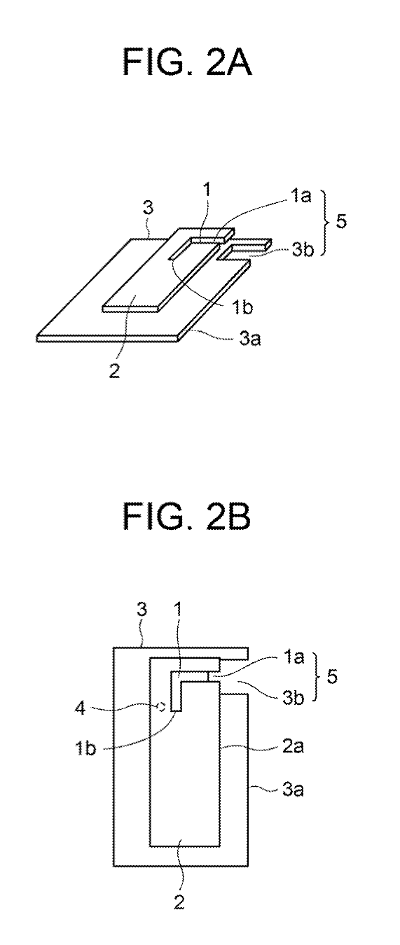

FIG. 3A is a perspective view showing a slot antenna according to EXAMPLE 3 of the present invention, and FIG. 3B is a plan view showing the slot antenna according to EXAMPLE 3 of the present invention;

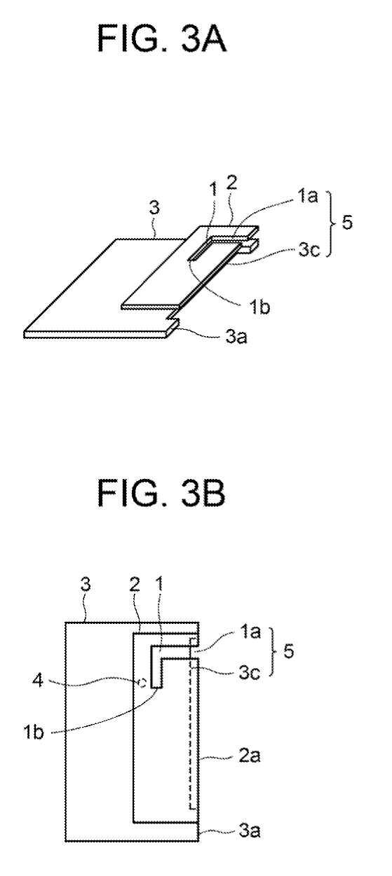

FIG. 4A is a perspective view showing a slot antenna according to EXAMPLE 4 of the present invention, and FIG. 4B is a plan view showing the slot antenna according to EXAMPLE 4 of the present invention;

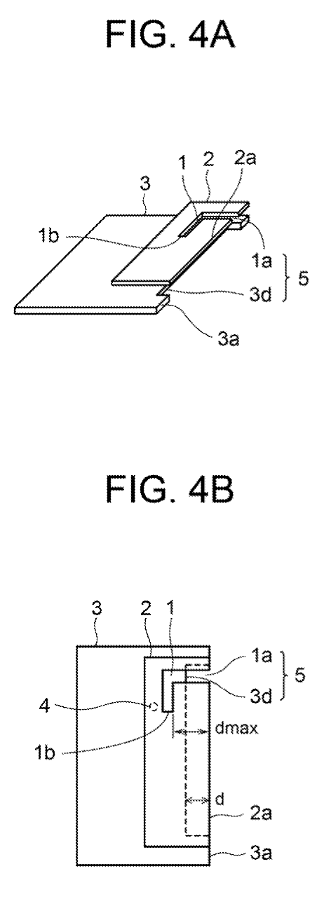

FIG. 5A is a characteristic chart showing an antenna impedance characteristic in EXAMPLE 1 of the present invention, FIG. 5B is a characteristic chart showing an antenna impedance characteristic in EXAMPLE 2 of the present invention, and FIG. 5C is a characteristic chart showing an antenna impedance characteristic according to a related technique;

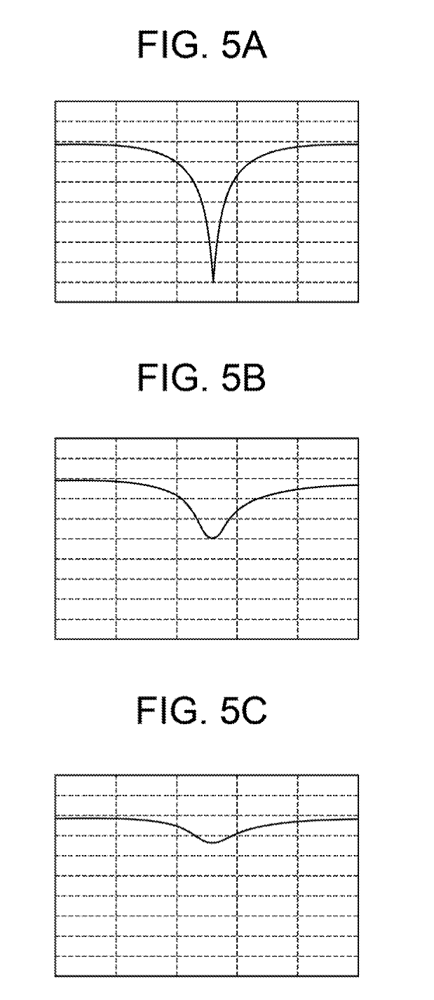

FIG. 6A is a perspective view showing a slot antenna according to EXAMPLE 5 of the present invention, FIG. 6B is a plan view showing the slot antenna according to EXAMPLE 5 of the present invention, and FIG. 6C is a sectional view showing the slot antenna according to EXAMPLE 5 of the present invention;

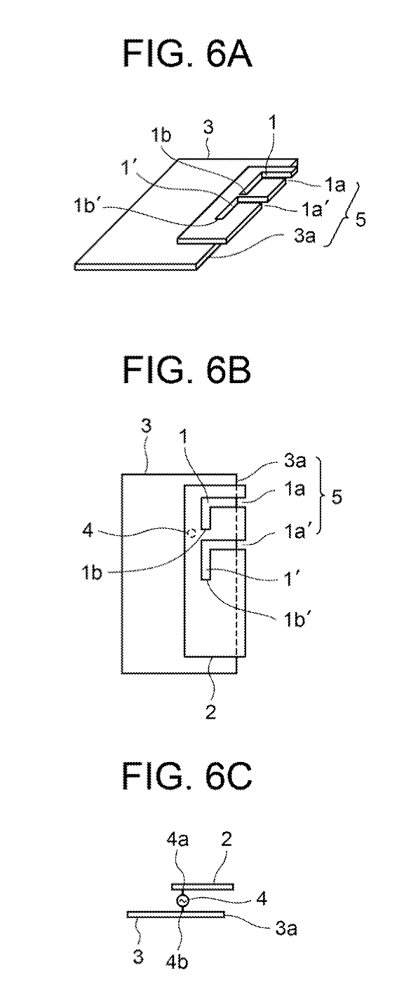

FIG. 7A is a perspective view showing a slot antenna according to EXAMPLE 6 of the present invention, FIG. 7B is a plan view showing the slot antenna according to EXAMPLE 6 of the present invention, and FIG. 7C is a sectional view showing the slot antenna according to EXAMPLE 6 of the present invention;

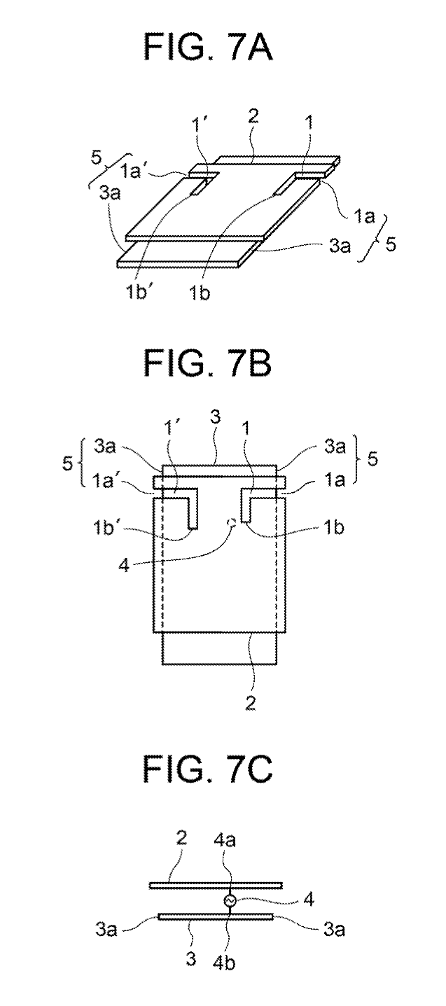

FIG. 8A is a perspective view showing a slot antenna according to EXAMPLE 7 of the present invention, and FIG. 8B is a plan view showing the slot antenna according to EXAMPLE 7 of the present invention;

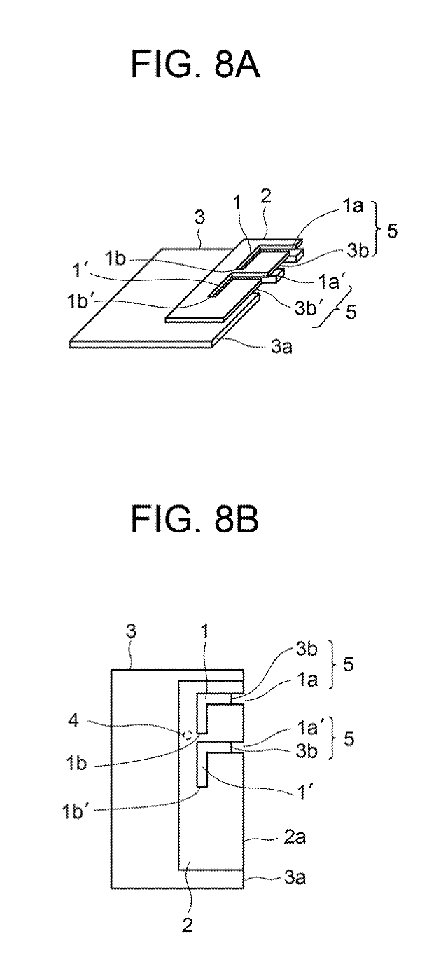

FIG. 9A is a perspective view showing a slot antenna according to EXAMPLE 8 of the present invention, and FIG. 9B is a plan view showing the slot antenna according to EXAMPLE 8 of the present invention;

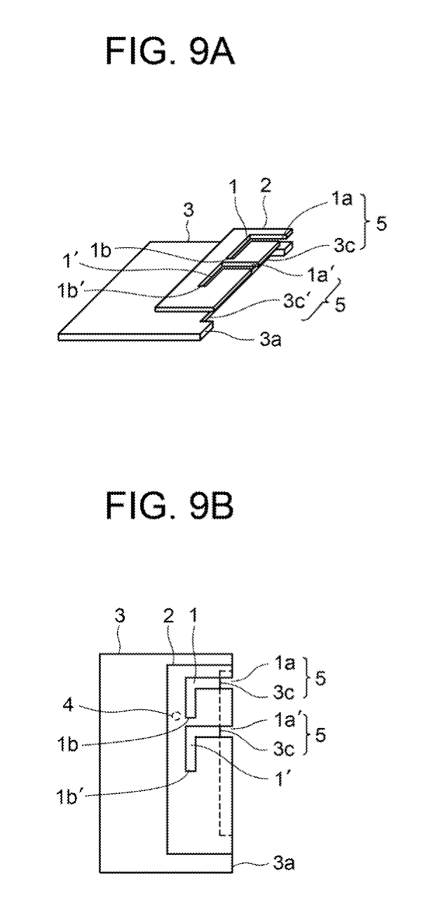

FIG. 10A is a perspective view showing a slot antenna according to EXAMPLE 9 of the present invention, and FIG. 10B is a plan view showing the slot antenna according to EXAMPLE 9 of the present invention;

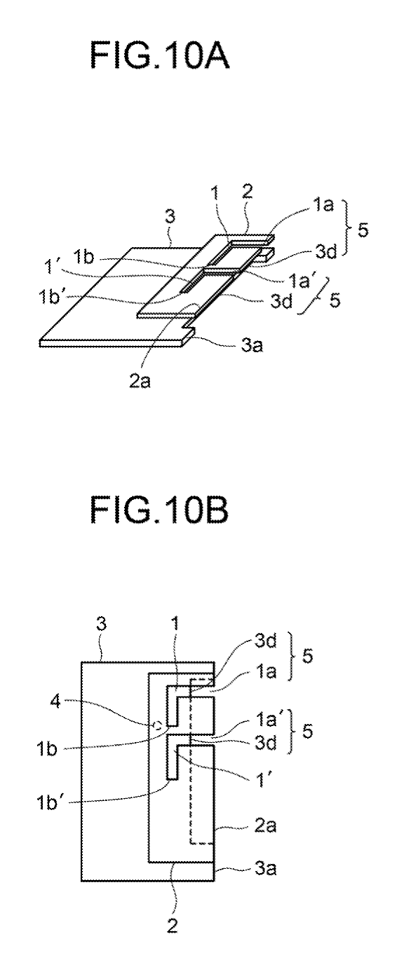

FIG. 11A is a characteristic chart showing an antenna impedance characteristic in EXAMPLE 5 of the present invention, FIG. 11B is a characteristic chart showing an antenna impedance characteristic in EXAMPLE 6 of the present invention, and FIG. 11C is a characteristic chart showing an antenna impedance characteristic according to a related technique;

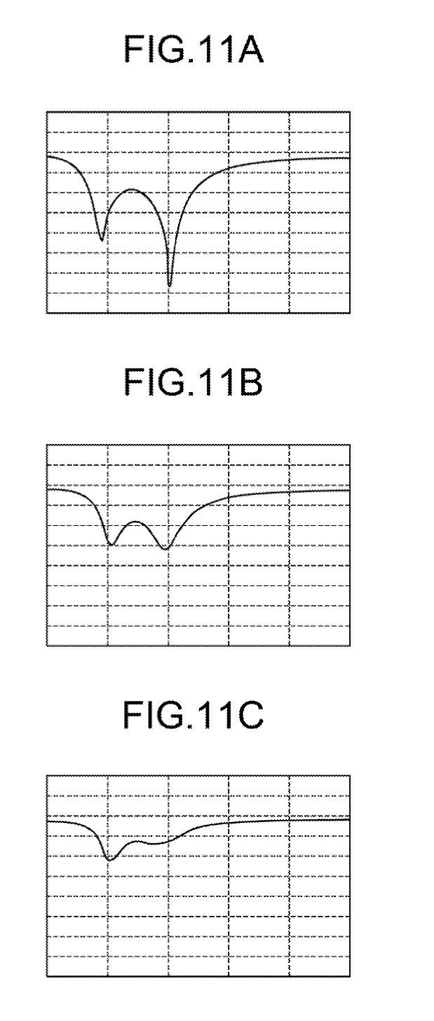

FIG. 12A is a perspective view taken from a front face side of a portable wireless terminal according to EXAMPLE 10 of the present invention, and FIG. 12B is a perspective view taken from a back face side of the portable wireless terminal according to EXAMPLE 10 of the present invention;

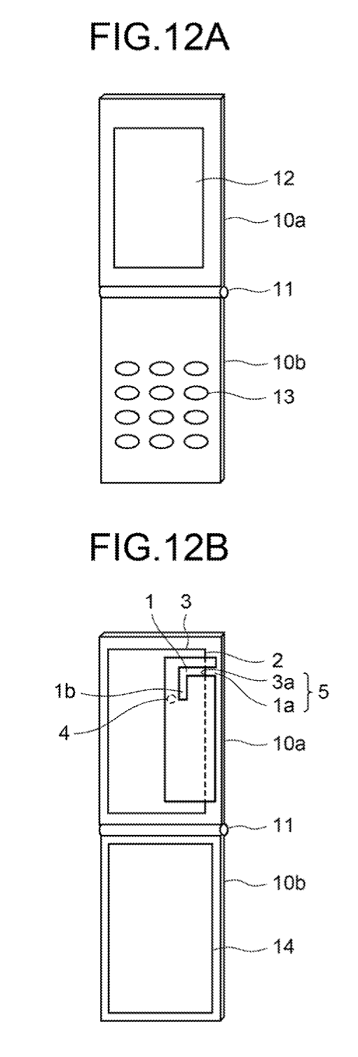

FIG. 13A is a perspective view taken from a front face side of a portable wireless terminal according to EXAMPLE 11 of the present invention, and FIG. 13B is a perspective view taken from a back face side of the portable wireless terminal according to EXAMPLE 11 of the present invention;

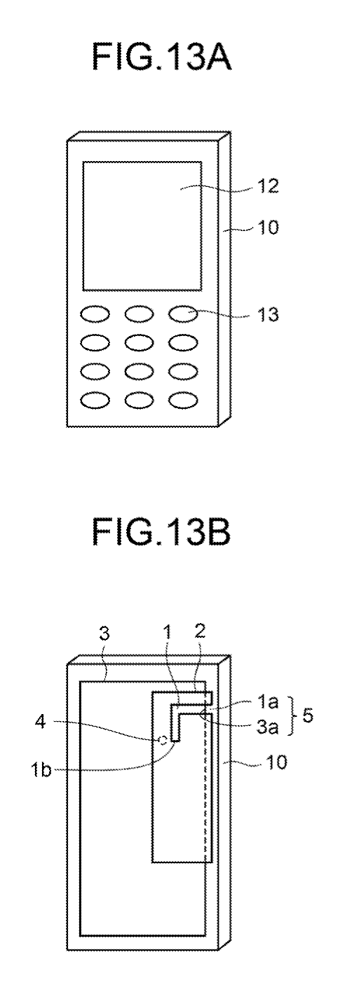

FIG. 14A is a perspective view taken from a front face side of a portable wireless terminal according to EXAMPLE 12 of the present invention, FIG. 14B is a perspective view taken from a back face side of the portable wireless terminal according to EXAMPLE 12 of the present invention, and FIG. 14C is a perspective view showing a state where the portable wireless terminal according to EXAMPLE 12 of the present invention is being folded;

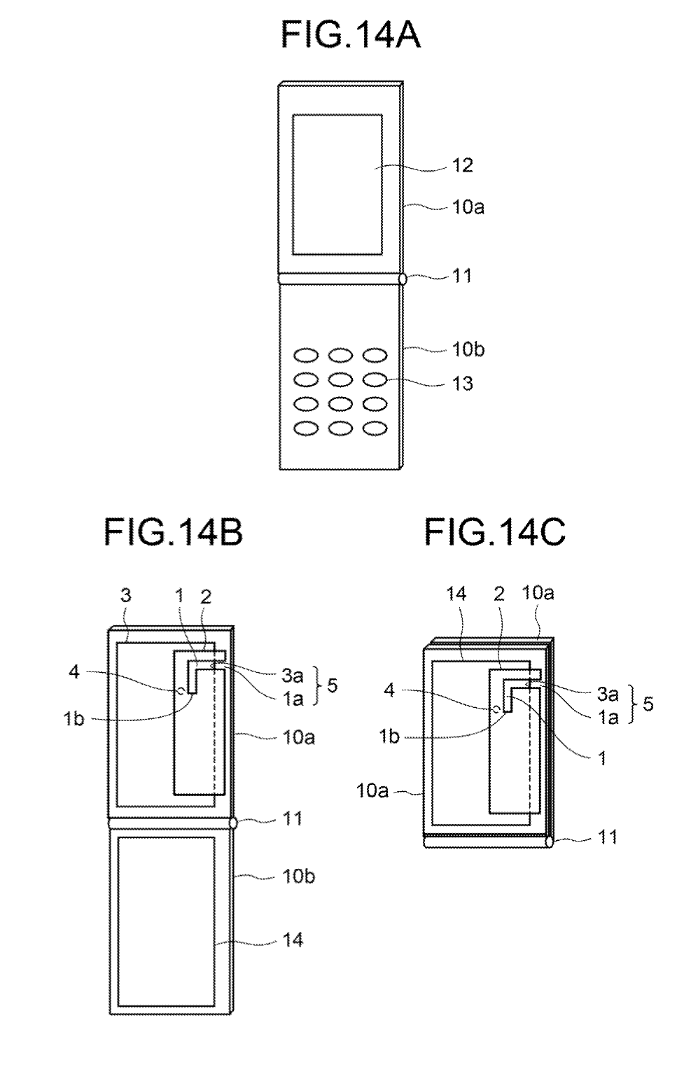

FIG. 15A is a detailed perspective view showing the related technique, and FIG. 158 is a sectional view thereof;

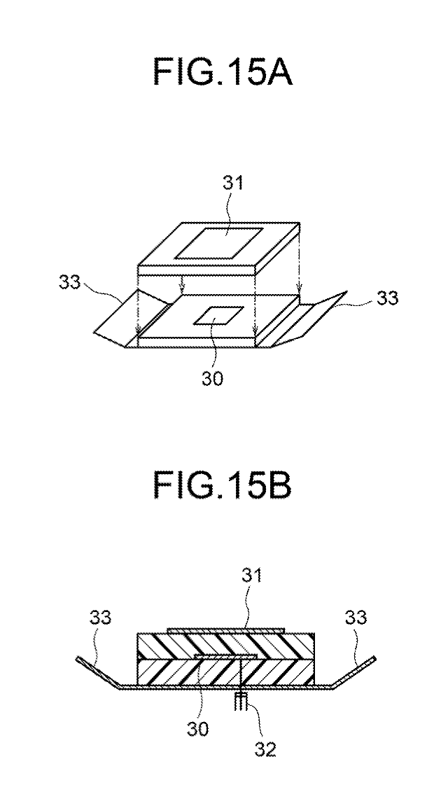

FIG. 16 is a sectional view showing a related technique; and

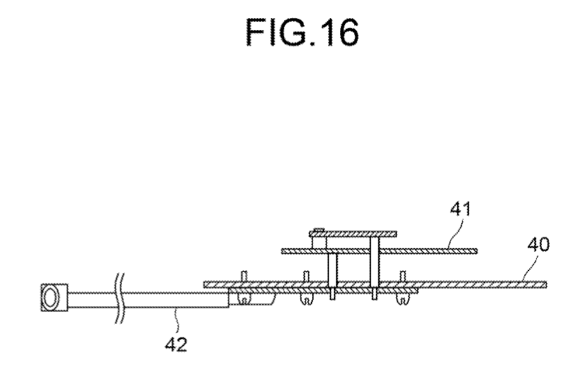

FIG. 17 is a perspective view showing a related technique.

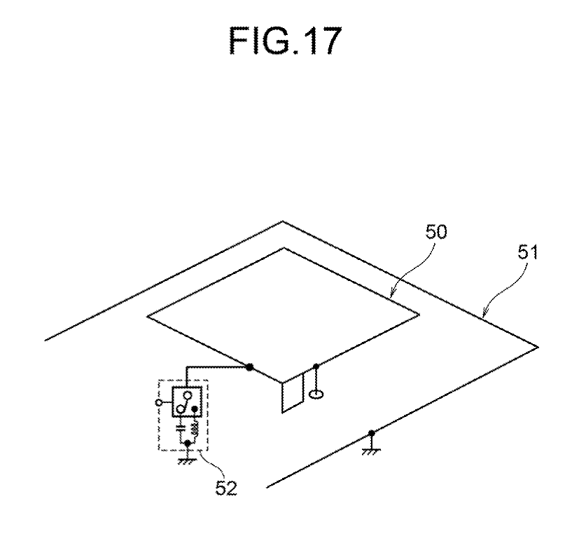

REFERENCE NUMERALS

| | |
|---|---|
| 1 | Slot |
| 1a | Opening end of slot |
| 1b | Short-circuit end of slot |
| 2 | Antenna element |
| 3 | Reflection plate |
| 3b, 3c, 3d | Notch |
| 4 | Power feeding device |
| 5 | Adjuster |
| 10, 10a, 10b | Casing of portable wireless terminal |

1. A slot antenna, comprising:
an antenna element having an aperture silt shaped slot;
a reflection plate disposed by being opposed to the antenna element; and
a power feeding device which is electrically and physically connected to the antenna element and the reflection plate, wherein
positions of an opening end of the slot and an end of the reflection plate are shifted from each other.

2. The slot antenna as claimed in claim 1, wherein the position of the opening end of the slot is shifted by being projected towards an outer side with respect to the end of the reflection plate.

3. The slot antenna as claimed in claim 1, wherein the opening end of the slot is disposed on an inner side with respect to the end of the reflection plate, and a notch opposing to the opening end of the slot is provided to the reflection plate.

4. The slot antenna as claimed in claim 1, wherein the notch opposing to the opening end of the slot is provided at the end of the reflection plate.

5. The slot antenna as claimed in claim 1, wherein the slot is a single-resonance type slot.

6. The slot antenna as claimed in claim 1, wherein the slot is a double-resonance type slot.

7. The slot antenna as claimed in claim 1, wherein a short-circuit end of the slot is disposed at a position opposing to the reflection plate.

8. The slot antenna as claimed in claim 1, wherein the antenna element is obtained by forming the slot on a metal-made flat emission plate.

9. The slot antenna as claimed in claim 1, wherein the slot has the opening end at an end of the emission plate.

10. The slot antenna as claimed in claim 1, wherein the reflection plate has a larger external size compared to an external size of the antenna element.

11. A portable wireless terminal having a slot antenna mounted into a casing of the portable wireless terminal, wherein
the slot antenna comprises:
an antenna element having an aperture silt shaped slot;
a reflection plate disposed by being opposed to the antenna element; and
a power feeding device which is electrically and physically connected to the antenna element and the reflection plate, wherein
positions of an opening end of the slot and an end of the reflection plate are shifted from each other.

12. The portable wireless terminal as claimed in claim 11, wherein the reflection plate is disposed at such a position that an influence to an antenna characteristic caused due to an external factor can be reduced.

13. The portable wireless terminal as claimed in claim 11, wherein:
the casing of the portable wireless terminal is a clamshell type structure;
the antenna element is mounted into one side of the casing that is being folded; and
a metal plate provided inside other side of the folded casing is mounted to the other side of the casing by avoiding an interference with the opening end of the slot.
